(19) United States
(12) Patent Application Publication
(10) Pub. No.: US 2007/0273108 A1
(43) Pub. Date: Nov. 29, 2007

(54) Wheel Chuck

(75) Inventors: Toru Kitatsuru, Logansport, IN (US); Andrew T. Wilcox, Westfield, IN (US)

Correspondence Address: BARNES & THORNBURG LLP, 600 ONE SUMMIT SQUARE, FORT WAYNE, IN, 46802, US

(73) Assignee: LOGANSPORT MATSUMOTO COMPANY, INC., Logansport, IN (US)

(21) Appl. No.: 11/749,229

(22) Filed: May 16, 2007

Related U.S. Application Data
(60) Provisional application No. 60/808,915, filed on May 26, 2006.

(51) Int. Cl. B23B 31/12

(52) U.S. Cl. 279/106

(57) ABSTRACT

A wheel chuck configured to accommodate various wheel diameters and styles, without time consuming changeovers. In some cases, the wheel chuck accommodates various wheel sizes using a mechanism that is less susceptible to clogging. The wheel chuck may include a sensor for detecting the presence of a wheel, which moves in conjunction with the wheel chuck's clamp assembly.

### PRIORITY CLAIM

This application claims priority to U.S. Provisional Application No. 60/808915, filed May 26, 2006, the entire disclosure of which is hereby incorporated by reference.

### TECHNICAL FIELD

This invention relates to work holding devices; in particular, this invention relates to a chuck for holding wheels.

### BACKGROUND

During manufacturing, wheels may be rotated at high speeds on a lathe. In some cases, for example, the lathe may be used to remove flash and gating from a wheel. The use of chucks to hold a wheel to the spindle of the lathe is well known. However, reconfiguring a chuck to accommodate various wheel diameters can be time consuming. Moreover, the mechanisms used to accommodate various wheel styles, which may have varying flange heights, lead to maintenance and durability difficulties. For example, mechanisms that have allowed this type of adjustment require changeover between wheel styles and tend to become clogged with machined chips, which require time consuming maintenance and downtime.

### SUMMARY

According to one aspect, the invention provides a wheel chuck with a face plate, a yoke plate and a clamping assembly. The face plate may be adapted to rotate about a drive axis while the yoke plate may be movable with respect to the face plate. The clamping assembly may include a finger clamp with a wheel engaging portion adapted to engage an automotive wheel. The finger clamp may be moved between an open position and a clamped position responsive to movement of the yoke plate with respect to the face plate. The clamping assembly may include a linkage mechanism that is pivotally connected to the finger clamp.

In some exemplary embodiments, the linkage mechanism may be capable of pivoting about at least two axes. For example, the linkage mechanism could include a first linkage member that pivots about a first axis and a second linkage member that pivots about a second axis. In some cases, the first linkage member and the second linkage member may be pivotally connected to the finger clamp. Embodiments are contemplated in which the first linkage member and the second linkage member may initially move the finger clamp approximately parallel to the drive axis and then radially away from the drive axis when the clamping assembly moves from the clamped position to the open position.

According to another aspect, the invention provides a wheel chuck comprising a face plate adapted to rotate about a drive axis and a yoke plate movable with respect to the face plate. The chuck may also include a first finger clamp, a second finger clamp and a third finger clamp associated with a first linkage mechanism, a second linkage mechanism and a third linkage mechanism, respectively. The linkage mechanisms may include linkage members that are pivotally connected to the finger clamps. Preferably, the finger clamps move between the open and clamped positions responsive to movement of the yoke plate with respect to the face plate.

Depending upon the particular circumstances, the finger clamps may be circumferentially spaced apart by approximately 120 degrees. In some embodiments, the linkage mechanisms may be approximately circumferentially aligned with the finger clamps. Embodiments are contemplated in which the linkage members may pivot about approximately parallel, but offset axes. In some embodiments, the finger clamps may define an opening therethrough that is dimensioned to receive a linear actuator.

In a further aspect, the invention provides a wheel chuck comprising a face plate adapted to rotate about a drive axis and a yoke plate movable with respect to the face plate. The chuck may include a clamping assembly adapted to engage an automotive wheel. Typically, the clamping assembly may move between an open position and a clamped position responsive to movement of the yoke plate with respect to the face plate. A linear actuator may be provided to drive the clamping assembly radially with respect to the drive axis between a first position and a second position, such that the clamping assembly can accommodate a larger diameter wheel in the second position compared to the first position. Preferably, the linear actuator is a power screw. In some such embodiments, the clamping assembly may include internal threads that engage external threads on the linear actuator. Embodiments are contemplated, however, that the linear actuator may be an air cylinder, a cam/cam follower, a chain assembly, a magnet assembly, a linear motor, a rack and pinion assembly or a hydraulic cylinder. Depending on the particular circumstances, the linear actuator may pass through an opening in the clamping assembly.

According to a still further aspect, the invention provides a wheel chuck that has a face plate adapted to rotate about a drive axis, a yoke plate that may move with respect to the face plate and a clamping assembly adapted to engage an automotive wheel. A sensor may also be provided to detect the presence of a wheel on the chuck. The sensor may be associated with the clamping assembly such that the sensor moves concomitant with the clamping assembly when the clamping assembly moves radially with respect to the drive axis. In some embodiments, the sensor may be carried on the clamping assembly. Embodiments are contemplated in which the sensor could be a pressure sensor, an ultrasonic sensor, a light-sensing sensor, or a proximity sensor.

### BRIEF DESCRIPTION OF THE DRAWINGS

The present disclosure will be described hereafter with reference to the attached drawings which are given as non-limiting examples only, in which:

FIG. 1 is a perspective view of a wheel chuck holding a wheel according to an embodiment of the present invention;

FIG. 2 is a partial side cross-sectional view of the clamping assembly shown in FIG. 1;

FIG. 3 is the partial cross-sectional view of the clamping assembly shown in FIG. 2, which has moved initially in an axial direction towards the open position;

FIG. 4 is the partial cross-sectional view of the clamping assembly shown in FIG. 2, which has moved to an open position;

FIG. 5 is a detailed cross-sectional view of the chuck shown in FIG. 1 in the clamping position;

FIG. 6 is a detailed cross-sectional view of the chuck shown in FIG. 5, which has moved to the open position;

FIG. 7 is a detailed cross-sectional view of the example chuck shown in FIG. 1;

FIG. 8 is a cross-sectional view of the example chuck shown in FIG. 1 with the clamping assembly positioned for a smaller diameter wheel than that of FIG. 9;

FIG. 9 is the cross-sectional view of the chuck shown in FIG. 8 with the clamping assembly moved to accommodate a larger diameter wheel than that of FIG. 8;

FIG. 10 is a top view of the example chuck shown in FIG. 1;

FIG. 11 is a detailed cross-sectional view of the chuck shown in FIG. 1 with the clamping assembly moved to a position to accommodate a smaller diameter wheel than that of FIG. 12;

FIG. 12 is the cross-sectional view of the chuck shown in FIG. 11, with the clamping assembly moved to accommodate a larger diameter wheel;

FIG. 13 is a detailed cross-sectional view of the example chuck shown in FIG. 1; and

FIG. 14 is a detailed cross-sectional view of the chuck shown in FIG. 1.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

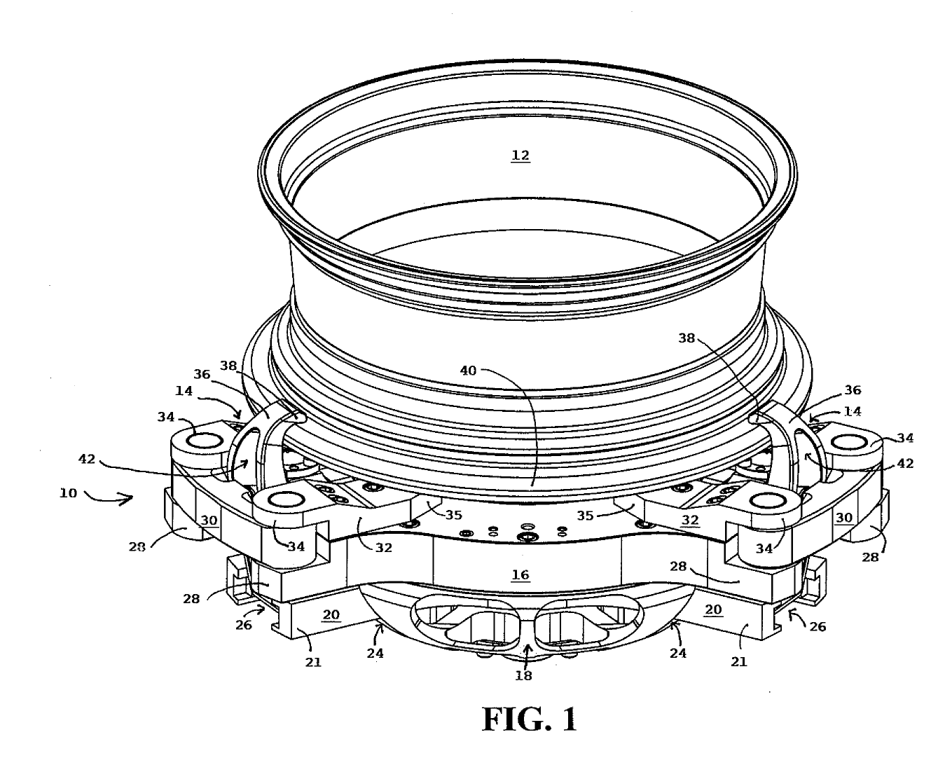

FIG. 1 shows an exemplary embodiment of a chuck 10 for holding a work piece, such as a wheel 12. Embodiments are contemplated that are specially adapted for use with an automotive wheel. By the term “automotive wheel,” it is meant a disk-like member that is configured to rotate about an axle of a vehicle and that is adapted to receive a tire, which is usually made of rubber reinforced with cords of nylon, fiberglass, or other material and filled with compressed air. For example, automotive wheels include but are not limited to wheels for trucks, cars, motorcycles, and golf carts.

In the example shown, the chuck 10 comprises a clamping assembly 14, a face plate 16, a riser adapter 18, and yoke plate 20. The clamping assembly 14 may be used to releaseably hold a wheel (or other work piece) to the chuck 10. In some embodiments, as described below, the clamping assembly 14 may be configured to accommodate variation in flange height between various wheel styles. The clamping assembly 14 may also move linearly in a radial direction relative to the wheel 12 to accommodate various wheel diameters in some embodiments, as described below.

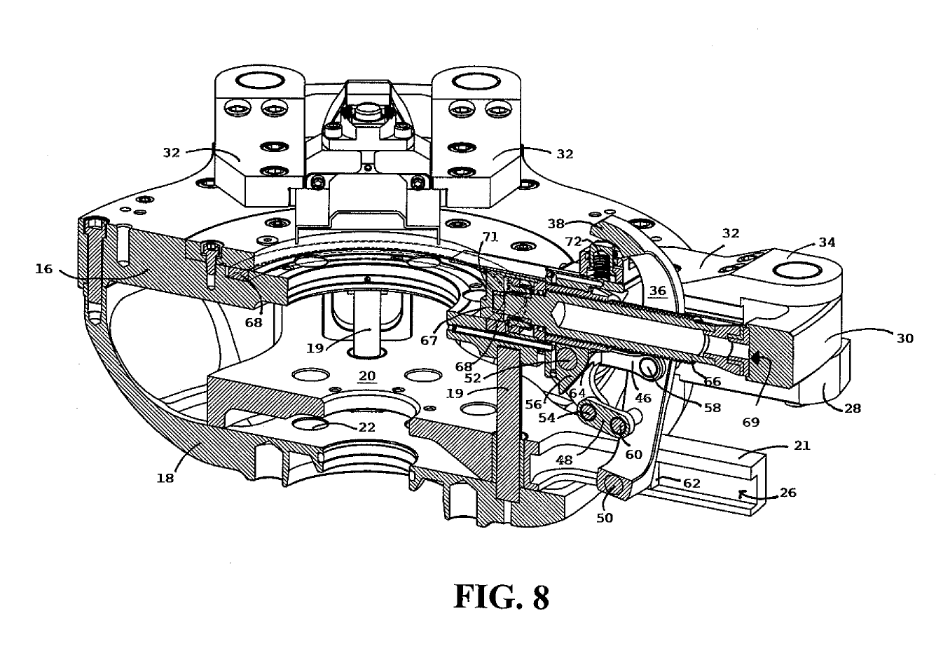

The riser adapter 18 may be used to couple the chuck 10 to a rotatable drive shaft (not shown), such as the spindle of a lathe. It should be appreciated that the riser adapter 18 may have various configurations for attachment to the lathe. In some embodiments, for example, the riser adapter 18 may include holes 22 (see FIG. 8) which are dimensioned to receive a bolt or other fastening device to connect the chuck 10 to a lathe.

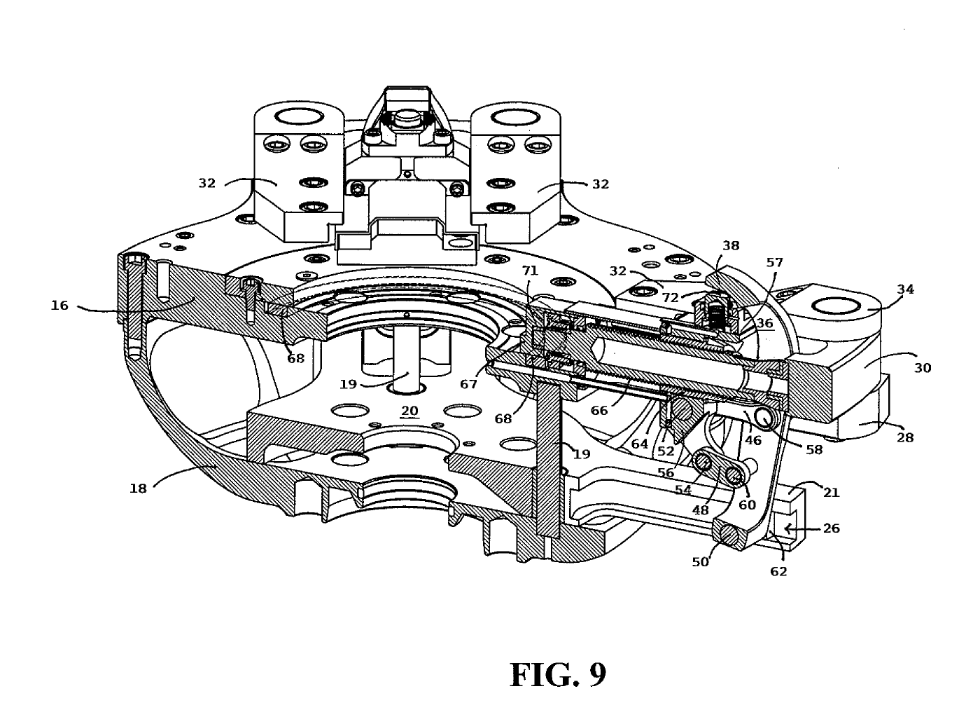

In some embodiments, the yoke plate 20 may be axially movable. For example a lathe or other device may axially drive the yoke plate 20. For example, the yoke plate 20 may be movable approximately along the longitudinal axis of the rotatable drive shaft. In the example embodiment shown, the riser adapter 18 and the face plate 16 are spaced apart to permit axial movement of the yoke plate 20 (as best seen in FIGS. 8 and 9). In some cases, guide rods 19 may be provided between the face plate 16 and the riser adapter 18 to guide axial movement of the yoke plate 20 (see FIGS. 8 and 9). In the example shown, the yoke plate 20 includes projections 21 that extend through slots 24 in the riser adapter 18. In the example shown, the projections 21 are spread circumferentially approximately 120 degrees apart from each other and approximately aligned with the clamping assemblies 14. To accommodate axial movement of the projections 21, the slots 24 may be sufficiently dimensioned to allow such axial movement of the yoke plate 20. In the embodiment shown, the projections 21 are shaped to form channels 26 dimensioned to receive a portion of the clamping assembly 14, as described below.

The face plate 16 may be coupled to the riser adapter 18 in some embodiments. It should be appreciated that various fasteners, such as bolts or screws, may be used to connect the face plate 16 to the riser adapter 18. In the example shown, the face plate 16 includes a pair of spaced apart extensions 28 that are approximately circumferentially aligned with the projections 21 and clamping assembly 14. Preferably, the extensions 28 are spaced apart sufficiently to receive a portion of the clamping assembly 14. In the example shown, stops 30 extend between the extensions 28. The stops 30 may be provided to limit movement of the clamping assembly 14. Some embodiments may include one or more coupling members 32 that connect the face plate 16 to the stops 30. As shown, the coupling members 32 include a first end 34 adjacent to an end of the stop 30 and an opposing second end 35 that is connected to the face plate 16.

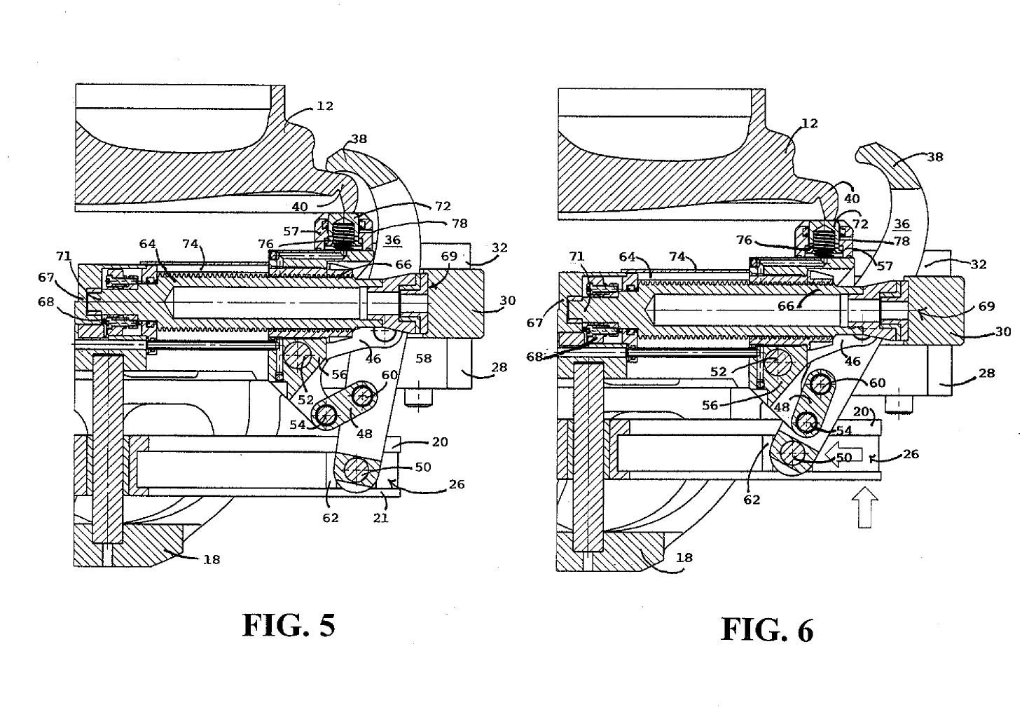

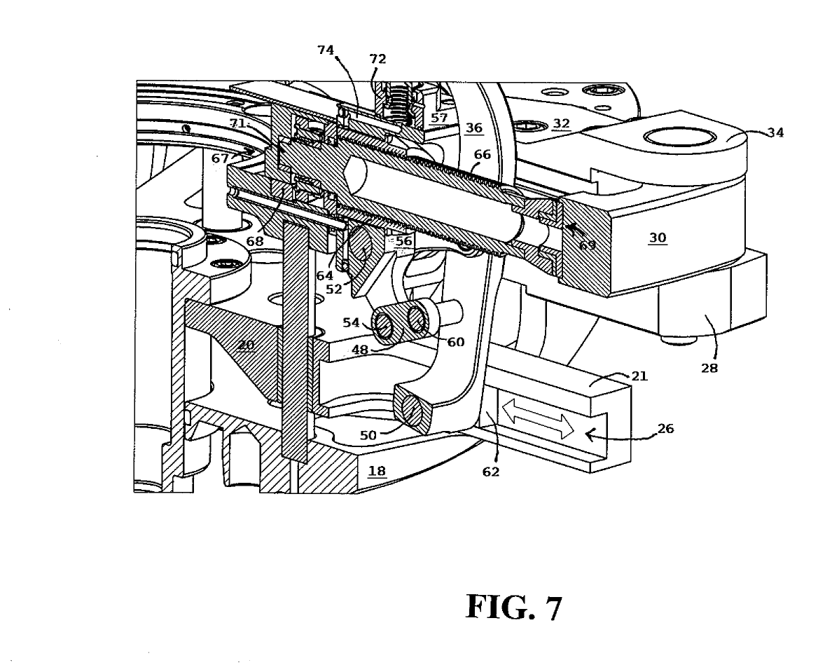

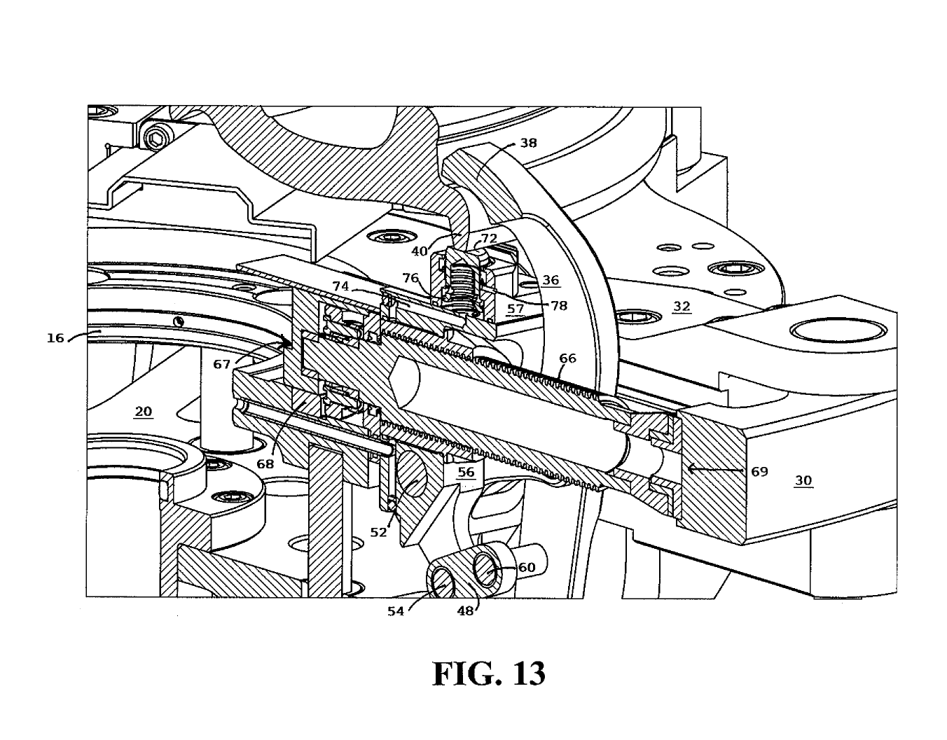

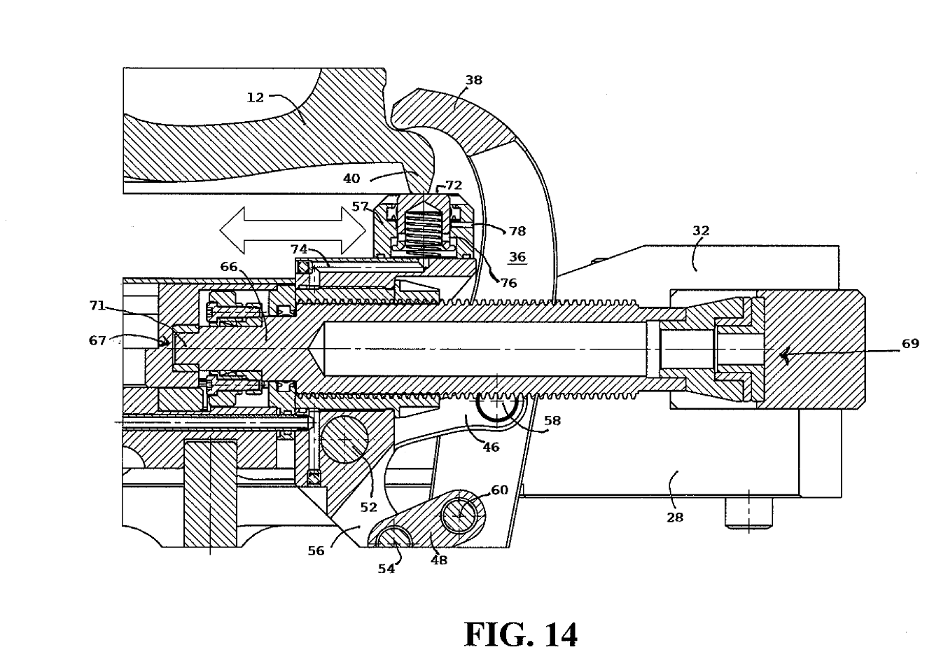

In the example embodiment shown, each clamping assembly 14 includes a finger clamp 36 that is positioned between the coupling members 32 and extensions 28. The finger clamps 36 may include a wheel engaging portion 38, which is configured to engage the flange 40 of the wheel 12. As shown, the wheel engaging portion 38 is arcuate in shape for purposes of example; however, it should be appreciated that the wheel engaging portion 38 may have other shapes that are configured to engage the wheel flange 40. In the embodiment shown, the finger clamp 36 includes a passage 42 that is dimensioned to receive a linear actuator 66 (see FIGS. 5-14); however, embodiments are also contemplated in which the linear actuator 66 may be positioned adjacent the finger clamp 36 or may be positioned on another location on the chuck 10, rather than passing through the finger clamp 36.

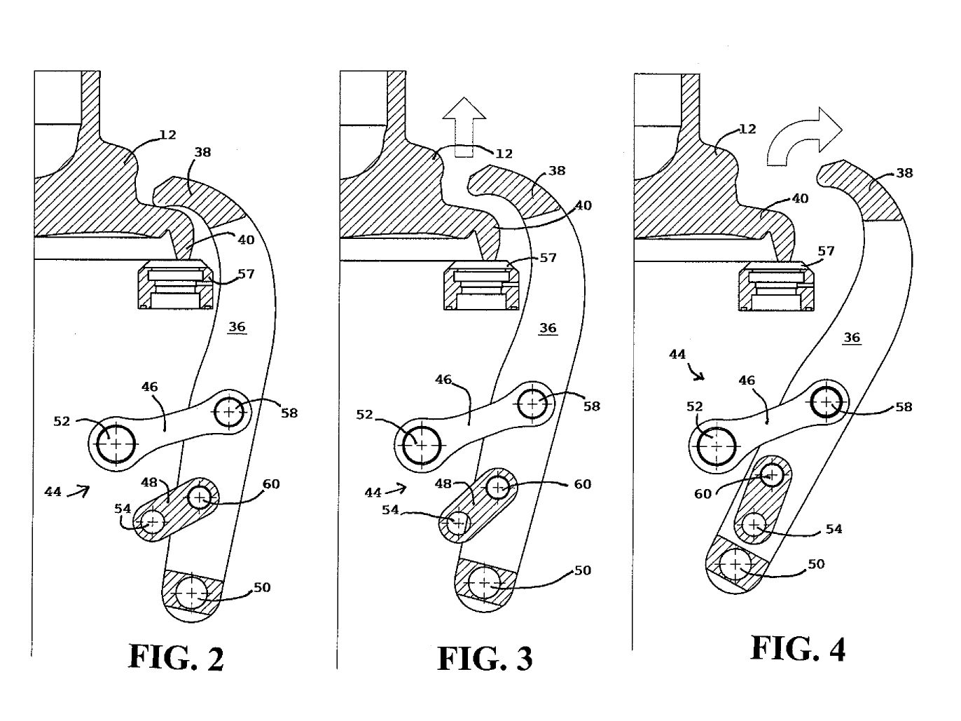

FIGS. 2 through 7 show movement of the finger clamp 36 between a clamped position and an open position. In the clamped position, the flange 40 of the wheel 12 is held between the wheel engaging end 38 of the finger clamp 36 and a part rest portion 57 of the clamping assembly 14. In the open position, the finger clamp 36 releases the wheel 12 for removal from the chuck 10.

In some embodiments, the wheel engaging end 38 of the finger clamp 36 moves initially from the clamped position in an axial direction (upward in the figures) and then in a radial direction (outward from the wheel 12) to release the wheel 12 from the chuck 10. This axial and radial movement of the wheel engaging end 38 allows the chuck 10 to accommodate variations in the flange 40 height that occurs between various wheel styles. As shown, the initial movement of the wheel engaging end 38 from the clamped position is primarily in the axial direction. As the finger clamp 36 continues movement, the wheel engaging end 38 also moves in the radial direction. In some embodiments, the wheel engaging end 38 moves in the axial direction for at least half of the stroke between the clamped position and the open position.

In the example shown, the clamping assembly 14 includes a linkage mechanism 44 that is not susceptible to clogging with metal chips (or other debris) as other mechanisms used to accommodate various flange heights. As shown, the linkage mechanism 44 translates movement of the wheel engaging end 38 in an initial axial movement and then a radial movement from the clamped position. For example, the linkage mechanism 44 may include a first linkage member 46, a second linkage member 48, and a clamp pivot 50. As shown, the first linkage member 46 and the second linkage member 48 include respective pivot points 52 and 54 that pivotably connect to a clamping assembly frame 56. In the example shown, the pivot points 52 and 54 are on opposite sides of the clamping assembly frame. The opposite ends of the first linkage member 46 and the second linkage member 48 are pivotally connected to the finger clamp 36 via pivot points 58 and 60, respectively. The clamp pivot 50 is pivotally connected to a slide member 62. When the clamp pivot 50 moves, the slide member 62 moves within the channel 26 formed in the yoke plate 20. It should be appreciated that the various dimensions and spatial relationships of the linkage members 46 and 48 could be used to cause the appropriate movement of the wheel engaging end 38 of the finger clamp 38.

In some embodiments, the axial movement of the yoke plate 20 actuates the movement of the finger clamp 36 between the clamped and open positions. When in the clamped position, the finger clamp 36 initially moves axially upon movement of the yoke plate 20. The linkage mechanism 44 causes the finger clamp 36 to rotate radially, which causes the clamp pivot 50 to move along the channel 26 via the slide member 62. In the embodiment shown, upward movement of the yoke plate 20 causes the finger clamp 36 to move to the open position while downward movement causes the finger clamp 36 to move to the clamped position.

In some embodiments, the clamping assembly 14 may be configured to move radially to accommodate a variety of wheel diameters. Preferably, a linear actuator 66 is associated with each clamping assembly 14. The linear actuator 66 drives the radial movement of the clamping assembly 14. Although a power screw is shown as the linear actuator 66 for purposes of example, it should be appreciated that other linear actuators, including but not limited to manually-operated, hydraulic, pneumatic, electrical, and electrohydraulic linear actuators could be used, such as an air cylinder, cam/cam follower, chain, magnet, linear motor, belt drive, rack and pinion, hydraulic cylinder or scroll.

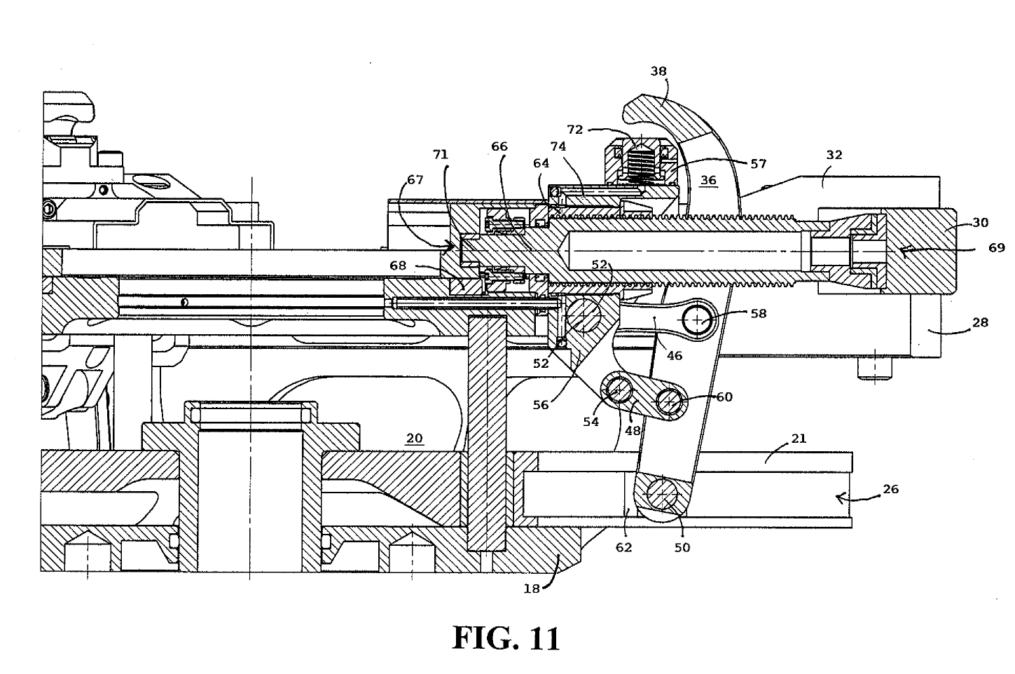

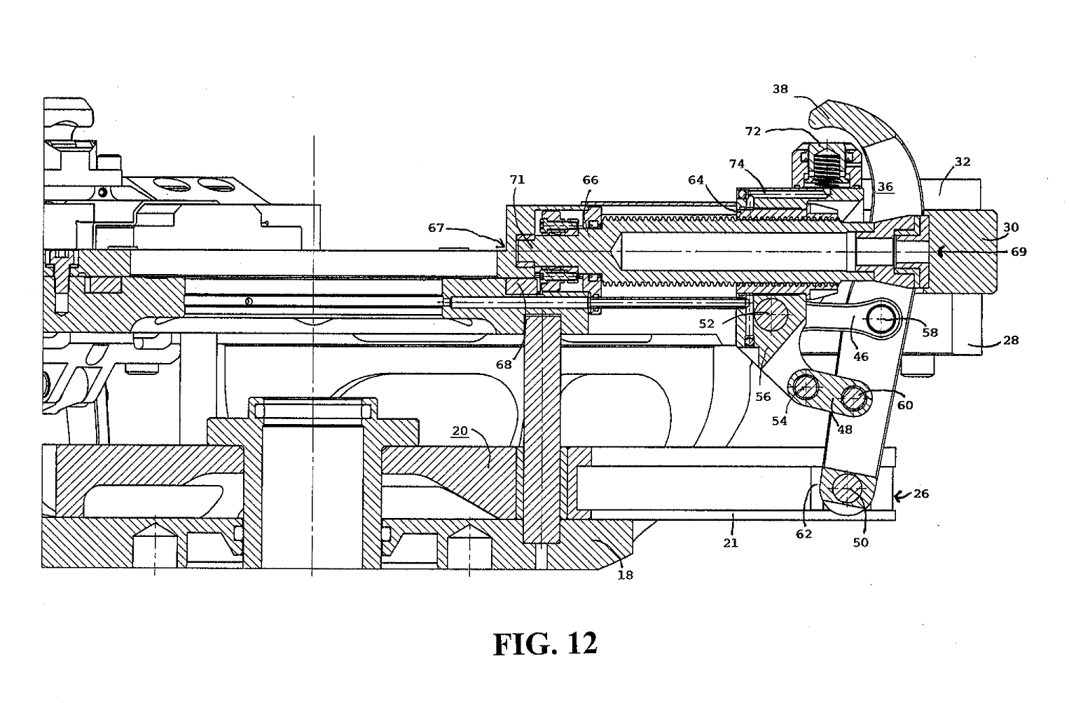

In the embodiment shown in FIGS. 8-12, the linear actuator 66 has a first end 67 with an input portion 71 and a second end 69 proximate the stop 30. In some embodiments, the linear actuator 66 may pass through the passage 42 in the finger clamp 36. As shown, the clamping assembly 14 includes a rotatable nut 64 with internal threads that engage the external threads of the linear actuator 66. Since the linear actuator 66 is a power screw in the example shown, the rotational movement of the linear actuator 66 causes linear movement of the nut 64, thereby moving the clamping assembly 14 between an extended and retracted position. In the extended position, the clamping assembly 14 may accommodate a large wheel diameter, as shown in FIGS. 9 and 12. In the retracted position, the clamping assembly 14 may accommodate a small wheel diameter, as shown in FIGS. 8 and 11. Of course, the clamping assembly 14 may be positioned to accommodate a variety of wheel diameters between the extended and retracted positions.

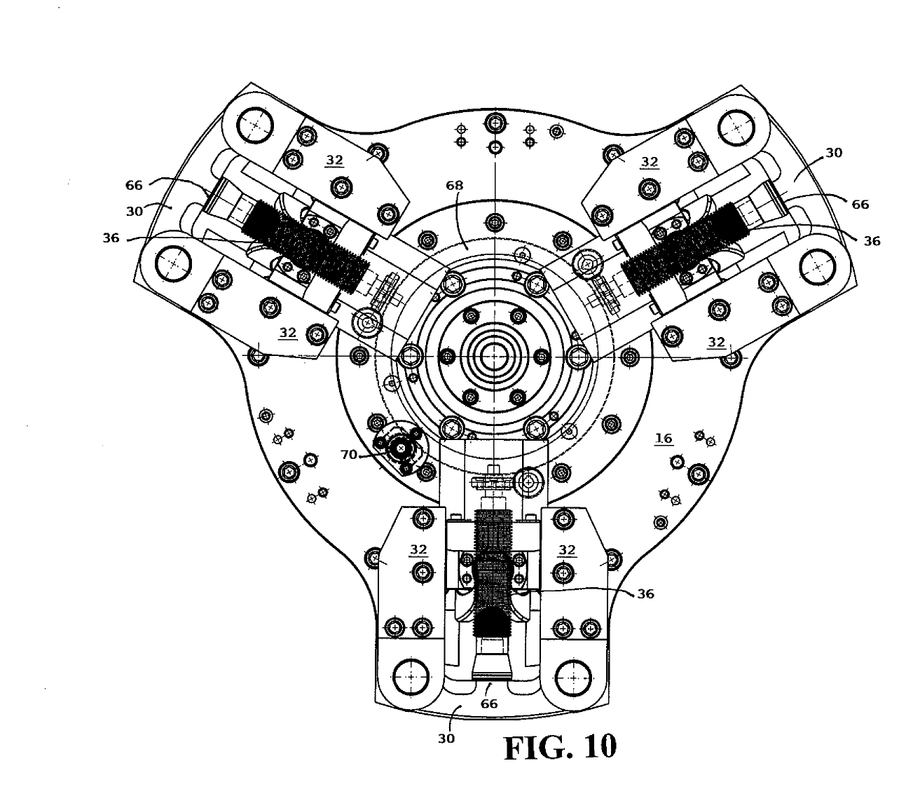

In some embodiments, the chuck 10 may have a mechanism to synchronize the radial movement of multiple clamping assemblies 14. For example, the chuck 10 may include a central gear 68 that simultaneously drives each linear actuator 66 on the chuck 10. For example, the input portion 71 of the linear actuator 66 may include a toothed portion that engages teeth on the central gear 68, which causes rotation of the linear actuator 66. In the embodiment shown in FIG. 10, for example, the chuck 10 includes three clamping assemblies 14 that are spaced circumferentially about 120 degrees apart from each other. The input portion 71 of each linear actuator 66 may be actuated by the rotation of the central gear 68. In some embodiments, the chuck 10 may include an adjustment mechanism 70 that rotates the central gear 68, thereby simultaneously rotating each linear actuator 66. Although the central gear 68 is shown for purposes of example, the synchronization of the linear actuators 66 may be controlled in other manners, such as by an electrical controller, cam/cam follower, linkage, scroll, hydraulic servo controller, air servo controller or other electronic and/or mechanical mechanism, which could be manually or automatically operated.

In some embodiments, the chuck 10 may include a sensor 72 that is configured to detect the presence of the wheel 12 on the chuck 10. As shown, the sensor 72 is carried on the part rest portion 57 of the clamping assembly 14. In such embodiments, the sensor 72 moves with the clamping assembly 14 between the retracted and extended positions described above. In the example shown, the chuck 10 includes a return channel 74 to accommodate air and/or wire(s) to connect to the sensor 72. For example, an air source may be in fluid communication with the interior of the sensor 72 via the return channel 74. The sensor 72 may include a hole 76 that aligns (or may be offset) with a sensor housing hole 78 when the wheel 12 contacts the sensor 72. A spring (not shown) may be provided to return the sensor 72 to a position that allows (or may prevent) air from escaping from the interior of the sensor 72. A pressure sensing mechanism (not shown) may be in fluid communication with the sensor 72 to determine the status of the sensor 72. It should be appreciated that various sensors could be used to detect the presence of a wheel on the chuck 10, such as ultrasonic sensors, light-sensing sensors, contact proximity sensors, or other an electrical or pressure sensors.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A wheel chuck comprising:
a face plate adapted to rotate about a drive axis;
a yoke plate movable with respect to said face plate;
a clamping assembly comprising a finger clamp and a linkage mechanism;
wherein said finger clamp includes a wheel engaging portion adapted to engage an automotive wheel;
wherein said finger clamp is movable between an open position and a clamped position responsive to movement of said yoke plate with respect to said face plate; and
wherein said finger clamp is pivotally connected to said linkage mechanism.

2. The wheel chuck of claim 1, wherein said linkage mechanism is capable of pivoting about at least two axes.

3. The wheel chuck of claim 1, wherein said linkage mechanism comprises a first linkage member pivotable about a first axis and a second linkage member pivotable about a second axis.

4. The wheel chuck of claim 3, wherein said first linkage member and said second linkage member are pivotally connected to said finger clamp.

5. The wheel chuck of claim 3, wherein said first linkage member and said second linkage member are adapted to move said finger clamp with an initial axial movement approximately parallel to said drive axis and then a radial movement away from said drive axis when said clamping assembly moves from said clamped position to said open position.

6. The wheel chuck of claim 3, wherein said first linkage member and said second linkage member are elongated in shape.

7. The wheel chuck of claim 6, wherein said first linkage member is longer than said second linkage member.

8. The wheel chuck of claim 4, wherein at least a portion of said finger clamp is positioned between said first linkage member and said second linkage member.

9. The wheel chuck of claim 1, wherein said wheel chuck includes multiple clamping assemblies spaced apart circumferentially approximately equidistant from each other, wherein said yoke plate includes multiple extensions that are approximately circumferentially aligned with said clamping assemblies.

10. The wheel chuck of claim 9, wherein each of said extensions include a channel portion, wherein said channel portion is dimensioned to receive a portion of said clamping assembly.

11. The wheel chuck of claim 10, wherein a portion of said clamping assembly slides in said channel when said yoke plate moves with respect to said face plate.

12. The wheel chuck of claim 1, further comprising a linear actuator configured to drive said clamping assembly toward and away from said drive axis, wherein said clamping assembly defines an opening that is dimensioned to receive said linear actuator.

13. The wheel chuck of claim 12, wherein said opening is defined in said finger clamp.

14. A wheel chuck comprising.
a face plate adapted to rotate about a drive axis;
a yoke plate movable with respect to said face plate;
a first finger clamp including a wheel engaging portion adapted to engage an automotive wheel;
a second finger clamp including a wheel engaging portion adapted to engage an automotive wheel;
a third finger clamp including a wheel engaging portion adapted to engage an automotive wheel;
a first linkage mechanism associated with said first finger clamp, wherein said first linkage mechanism comprises a first linkage member and a second linkage member pivotally connected to said first finger clamp;
a second linkage mechanism associated with said second finger clamp, wherein said second linkage mechanism comprises a third linkage member and a fourth linkage member pivotally connected to said second finger clamp;
a third linkage mechanism associated with said third finger clamp, wherein said third linkage mechanism comprises a fifth linkage member and a sixth linkage member pivotally connected to said third finger clamp; and
wherein said first finger clamp, said second finger clamp and said third finger clamp are movable between an open position and a clamped position responsive to movement of said yoke plate with respect to said face plate.

15. The wheel chuck of claim 14, wherein said first finger clamp, said second finger clamp, and said third finger clamp are circumferentially spaced apart by approximately 120 degrees.

16. The wheel chuck of claim 15, wherein said first linkage member, said second linkage member, and said third linkage member are approximately circumferentially aligned with said first finger clamp, said second finger clamp, and said third finger clamp, respectively.

17. The wheel chuck of claim 14, wherein said first linkage member and said second linkage member pivot about approximately parallel, but offset axes.

18. The wheel chuck of claim 17, wherein said third linkage member and said fourth linkage member pivot about approximately parallel, but offset axes.

19. The wheel chuck of claim 18, wherein said fifth linkage member and said sixth linkage member pivot about approximately parallel, but offset axes.

20. The wheel chuck of claim 14, wherein said first finger clamp, said second finger clamp, and said third finger clamp each define an opening therethrough that is dimensioned to receive a linear actuator.

21. A wheel chuck comprising:
a face plate adapted to rotate about a drive axis;
a yoke plate movable with respect to said face plate;
a clamping assembly adapted to engage an automotive wheel, wherein said clamping assembly is movable between an open position and a clamped position responsive to movement of said yoke plate with respect to said face plate;
a linear actuator adapted to drive said clamping assembly radially with respect to said drive axis between a first position and a second position, wherein said clamping assembly can accommodate a larger diameter wheel in said second position compared to said first position; and
wherein said linear actuator is a power screw.

22. The wheel chuck of claim 21, wherein said linear actuator is selected from the group consisting of an air cylinder, a cam/cam follower, a chain assembly, a magnet assembly, a linear motor, a rack and pinion assembly and a hydraulic cylinder.

23. The wheel chuck of claim 21, wherein said linear actuator extends radially from said drive axis.

24. The wheel chuck of claim 21, wherein said clamping assembly includes internal threads that engage external threads on said linear actuator.

25. The wheel chuck of claim 21, wherein said clamping assembly includes a finger clamp with an opening therethrough and wherein said linear actuator passes through said opening.

26. The wheel chuck of claim 21, wherein said wheel chuck comprises three clamping assemblies that are circumferentially spaced apart by approximately 120 degrees and wherein said wheel chuck comprises at least three power screws that are approximately circumferentially aligned with said clamping assemblies.

27. The wheel chuck of claim 26, further comprising a synchronizing member configured to simultaneously drive said power screws.

28. The wheel chuck of claim 27, wherein said synchronizing member is a gear that simultaneously engages a toothed portion on each of said power screws.

29. The wheel chuck of claim 28, wherein said gear is approximately concentric with respect to said drive axis.

30. The wheel chuck of claim 21, further comprising a sensor configured to detect the presence of a wheel on said wheel chuck, wherein said linear actuator is configured to radially drive said sensor toward and away from said drive axis concurrent with movement of said clamping assembly traveling between said first position and said second position.

31. A wheel chuck comprising:
a face plate adapted to rotate about a drive axis;
a yoke plate movable with respect to said face plate;
a clamping assembly adapted to engage an automotive wheel;
a sensor configured to detect the presence of a wheel on said wheel chuck;
wherein said clamping assembly is movable between an open position and a clamped position responsive to movement of said yoke plate with respect to said face plate;
wherein said clamping assembly is configured to move radially with respect to said drive axis between a first position and a second position, wherein said clamping assembly can accommodate a larger diameter wheel in said second position compared to said first position; and
wherein said sensor is associated with said clamping assembly such that said sensor moves concomitant with said clamping assembly when said clamping assembly moves between said first position and said second position.

32. The wheel chuck of claim 31, wherein said sensor is carried on said clamping assembly.

33. The wheel chuck of claim 31, wherein said sensor is a pressure sensor.

34. The wheel chuck of claim 31, wherein said sensor is selected from the group consisting of an ultrasonic sensor, a light-sensing sensor, and a proximity sensor.

35. The wheel chuck of claim 31, further comprising a linear actuator adapted to drive said clamping assembly between said first position and said second position.

36. The wheel chuck of claim 35, wherein said linear actuator is positioned between said sensor and said yoke plate.
